(19) United States
(12) Patent Application Publication
(10) Pub. No.: US 2024/0171124 A1
(43) Pub. Date: May 23, 2024

(54) SOLAR ENERGY SYSTEM FOR POWERING AN ELECTRONIC ELEMENT

(71) Applicant: SOLARGIK LTD, Jerusalem (IL)

(72) Inventors: Yossi Azancot, Jerusalem (IL); Avi Chamavi, Gedera (IL); Greg Ravikovich, Mevaseret Tzion (IL); Gil Kroyzer, Jerusalem (IL); Israel Kroizer, Jerusalem (IL); Morag Am Shallem, Jerusalem (IL)

(21) Appl. No.: 17/989,728

(22) Filed: Nov. 18, 2022

(51) Int. Cl. H02S 40/36; H02S 40/32; H02S 40/38

(52) U.S. Cl. CPC H02S 40/36; H02S 40/32; H02S 40/38

(57) ABSTRACT

A solar energy system comprising a plurality of photovoltaic (PV) panels for production of electricity, electrically coupled to a recipient system. Each of the PV panels includes a negative terminal and a positive terminal. An electronic element, including at least one component requiring power for operation or charging thereof, is electrically connected to the negative terminal and to the positive terminal of one of the plurality of PV panels. Electricity for powering the electronic element is tapped from electricity produced by the one of the plurality of PV panels, such that the quantity of produced electricity delivered to the recipient system is reduced.

### FIELD OF THE INVENTION

The present invention relates to solar energy systems and specifically to systems and methods utilizing the solar energy collected in solar energy systems to power electronic controllers, particularly controllers relating to operation of the solar energy system.

### BACKGROUND

Achieving a diversified low-carbon emissions energy economy has been limited by economic and technological limitations. Solar energy systems comprising photovoltaic (PV) arrays of PV cells are commonly deployed to capture energy from both direct and diffuse (including reflected) solar irradiance, for the purpose of generating electricity.

Tracking PV systems are solar systems in which PV arrays are pivoted to increase the capture of direct energy, and to reduce the cosine losses of the direct irradiance component. Such tracking systems are typically controlled by an electronic controller, which is typically powered by connection to a power grid, or by a backup-power battery. An example of such a tracking system is described in U.S. patent application Ser. No. 17/845,196, filed Jun. 21, 2022 and entitled SOLAR ENERGY SYSTEM AND GEARED DRIVE SYSTEM, which is incorporated by reference as if fully set forth herein.

However, power supply to the electronic controller is often complex, for example requiring wiring to a remote connection to the grid, or frequent changing or charging of batteries. There is therefore a need for a method and system for improved powering an electronic controller, such as a controller of a PV tracker.

### SUMMARY

According to embodiments of the present invention, a solar energy system includes:
a plurality of photovoltaic (PV) panels for production of electricity, the plurality of PV panels being electrically coupled to a recipient system receiving the produced electricity, each of the PV panels including a negative terminal and a positive terminal; and
an electronic element, including at least one component requiring power for operation or charging thereof, the electronic component being electrically connected to the negative terminal and to the positive terminal of one of the plurality of PV panels,
wherein, electricity for charging or powering the electronic element is tapped from electricity produced by the one of the plurality of PV panels, reducing an amount of the produced electricity being delivered to the recipient system.

In some embodiments, the plurality of PV panels are electrically coupled to each other, in series, to form a string of PV panels, and the string of PV panels is electrically coupled to the recipient system, and the electronic element being electrically connected to the negative terminal and to the positive terminal between the one of the plurality of PV panels, and neighboring PV panels in the string of PV panels.

In some embodiments, the plurality of PV panels are electrically coupled to the recipient system in parallel, and the electronic element being electrically connected to the negative terminal and to the positive terminal between the one of the plurality of PV panels, and the recipient system.

In some embodiments, the solar energy system further includes a plurality of DC to DC converters.

In some such embodiments, each of the plurality of PV panels is electrically coupled to a corresponding one of the plurality of DC to DC converters, the plurality of DC to DC converters are electrically coupled to the recipient system, and the electronic element being electrically connected to the negative terminal and to the positive terminal between the one of the plurality of PV panels and the corresponding DC to DC converter.

In some other embodiments, the plurality of PV panels is divided into sub-groups, each sub-group being electrically coupled to one of the plurality of DC to DC converters, the plurality of DC to DC converters are electrically coupled to the recipient system, and the electronic element being electrically connected to the negative terminal and to the positive terminal of a PV panel in one of the sub-groups.

In some embodiments, the PV panels in at least one of the sub-groups are electrically coupled in series to the one of the plurality of DC to DC converters, and the electronic element is electrically connected to the negative terminal and to the positive terminal between the PV panel in the one of the sub-groups and at least one other PV panel in the one of the sub-groups.

In some embodiments, the PV panels in at least one of the sub-groups are electrically coupled in parallel to the one of the plurality of DC to DC converters, and the electronic element is electrically connected to the negative terminal and to the positive terminal between the PV panel in the one of the sub-groups and the one of the plurality of DC to DC converters.

In some embodiments, the plurality of DC to DC converters are electrically coupled to the recipient system in series.

In some embodiments, the plurality of DC to DC converters are electrically coupled to the recipient system in parallel.

In some embodiments, the recipient system includes a DC to AC inverter, adapted to transmit electricity produced by the PV panels to an electrical grid.

In some embodiments, the recipient system includes a battery, adapted to be charged by electricity produced by the PV panels.

In some embodiments, the electronic element includes at least one battery, adapted to be charged by electricity tapped from the one of the plurality of PV panels.

In some embodiments, the electronic element includes at least one processor adapted to be powered by electricity tapped from the one of the plurality of PV panels.

In some embodiments, the electronic element includes at least one sensor adapted to be powered by electricity tapped from the one of the plurality of PV panels.

In some embodiments, the electronic element includes at least one motor adapted to be powered by electricity tapped from the one of the plurality of PV panels.

In some embodiments, the electronic element includes at least one output element adapted to be powered by electricity tapped from the one of the plurality of PV panels.

In some embodiments, the electronic element includes at least one communication interface adapted to be powered by electricity tapped from the one of the plurality of PV panels.

In some embodiments, the solar energy system further includes a support subassembly having at least a subset of the plurality of PV panels mounted thereonto, the support subassembly and the subset of PV panels mounted thereonto being pivotable about a longitudinal axis of the support subassembly.

In some embodiments, the solar energy system further includes a drive system adapted to pivot the support subassembly and the subset of the plurality of PV panels mounted thereonto. The electronic element includes at least a portion of the drive system, which is powered or charged by electricity tapped from the one of the plurality of PV panels.

In some embodiments, the electronic element includes at least one of a motor, a CPU, and a controller of the drive system, adapted to be powered by the electricity tapped from the one of the plurality of PV panels.

In some embodiments, the electronic element includes a backup battery of the drive system, adapted to be charged by the electricity tapped from the one of the plurality of PV panels, and to power other components of the drive system.

In some embodiments, the one of the plurality of PV panels is included in the subset of PV panels mounted onto the support subassembly.

In some embodiments, the one of the plurality of PV panels is excluded from the subset of PV panels mounted onto the support subassembly.

In some embodiments, all of the plurality of PV panels are mounted onto the support subassembly.

In some embodiments, the solar energy system further includes a second pivotable support subassembly having a second subset of the plurality of PV panels mounted thereonto, the second pivotable support subassembly being functionally associated with a second drive system adapted to pivot the second pivotable support subassembly.

In some embodiments, at least a portion of the second drive system is electrically coupled to the negative terminal and to the positive terminal of another one of the plurality of PV panels, such that electricity for powering of the portion of the second drive system is tapped from electricity generated by the another one of the plurality of PV panels.

In some embodiments, the another one of the plurality of PV panels is included in the second subset mounted onto the second pivotable support assembly.

In some embodiments, the another one of the plurality of PV panels is included in the subset mounted onto the support assembly.

According to embodiments of the present invention, there is provided a method of charging a battery using a plurality of PV panels for production of electricity, the plurality of PV panels delivering produced electricity to a recipient system, each of the PV panels including a negative terminal and a positive terminal. The method includes:
electrically connecting the battery to the negative terminal and to the positive terminal of one of the plurality of PV panels; and
tapping electricity for charging the battery from electricity produced by the one of the plurality of PV panels, thereby reducing the quantity of produced electricity being delivered to the recipient system.

According to embodiments of the present invention, there is provided a method of powering an electronic element using a plurality of PV panels for production of electricity, the plurality of PV panels delivering produced electricity to a recipient system, each of the PV panels including a negative terminal and a positive terminal. The method includes:
electrically connecting the electronic element to the negative terminal and to the positive terminal of one of the plurality of PV panels; and
tapping electricity for powering the electronic element from electricity produced by the one of the plurality of PV panels, thereby reducing the quantity of produced electricity being delivered to the inverter.

In some embodiments, the plurality of PV panels are electrically coupled to each other, in series, to form a string of PV panels, and the string of PV panels is electrically coupled to the recipient system and wherein the electrically connecting includes electrically connecting the battery or the electronic element to the negative terminal and to the positive terminal between the one of the plurality of PV panels, and neighboring PV panels in the string of PV panels.

In some embodiments, the plurality of PV panels are electrically coupled to the recipient system in parallel, and wherein the electrically connecting includes electrically connecting the battery or the electronic element to the negative terminal and to the positive terminal between the one of the plurality of PV panels, and the recipient system.

In some embodiments, each of the plurality of PV panels is electrically coupled to a corresponding one of a plurality of DC to DC converters, which are electrically coupled to the recipient system, and wherein the electrically connecting includes electrically connecting the battery or the electronic element to the negative terminal and to the positive terminal between the one of the plurality of PV panels and the corresponding DC to DC converter.

In some embodiments, the plurality of PV panels is divided into sub-groups, each sub-group being electrically coupled to one of a plurality of DC to DC converters, which are electrically coupled to the recipient system, and wherein the electrically connecting includes electrically connecting the battery or the electronic element to the negative terminal and to the positive terminal of a PV panel in one of the sub-groups.

In some embodiments, the PV panels in at least one of the sub-groups are electrically coupled in series to the one of the plurality of DC to DC converters, and the electrically connecting includes electrically connecting the battery or the electronic element to the negative terminal and to the positive terminal between the PV panel in the one of the sub-groups and at least one other PV panel in the one of the sub-groups.

In some embodiments, the PV panels in at least one of the sub-groups are electrically coupled in parallel to the one of the plurality of DC to DC converters, and the electrically connecting includes electrically connecting the battery or the electronic element to the negative terminal and to the positive terminal between the PV panel in the one of the sub-groups and the one of the plurality of DC to DC converters.

According to embodiments of the present invention, there is provided a method of driving pivoting of a PV assembly including an array of PV panels mounted onto a support subassembly, the support subassembly being pivotable when driven to pivot by a drive system. The method includes:
electrically connecting the drive system to a negative terminal and to a positive terminal of a specific PV panel for production of electricity, the specific PV panel being electrically coupled to a recipient system; and
using electricity tapped from electricity generated by the specific PV panel, powering the drive system to drive pivoting of the support subassembly and the array of PV panels mounted thereon.

In some embodiments, the powering of the drive system by the tapped electricity causes a reduction in the electricity produced by the specific PV panel and delivered to the recipient system.

In some embodiments, the specific PV panel forms part of the array of PV panels mounted onto the support subassembly.

In some embodiments, the specific PV panel is not mounted onto the support subassembly.

In the specification and claim which follows, the acronym PV is intended to mean PV cells and likewise PV cell arrays, or panels, as known in the art.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1A is a schematic illustration of a photovoltaic (PV) energy system powering an electronic element according to embodiments of the present invention.

FIG. 1B is a schematic illustration of a PV energy system powering an electronic element according to embodiments of the present invention.

FIG. 1C is a schematic illustration of a PV energy system powering an electronic element according to embodiments of the present invention.

FIG. 1D is a schematic illustration of a PV energy system powering an electronic element according to embodiments of the present invention.

FIG. 2A is a schematic perspective-view illustration of a support subassembly of a PV assembly and a drive system, the drive system including a motor unit powered by the PV energy system of any one of FIGS. 1A to 1D according to embodiments of the present invention.

FIG. 2B shows an enlarged detail from FIG. 2A, including the drive system.

FIG. 2C is a schematic perspective-view illustration of a photovoltaic (PV) energy system mounted onto the support subassembly of FIG. 2A, according to embodiments of the present invention.

FIG. 2D shows an enlarged detail from FIG. 2C, including the drive system.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

A ‘solar energy system’ as used herein means a system for generating or producing electricity using an array of photovoltaic (PV) modules. The system can include an inverter for converting the direct-current (DC) electricity generated by the PV modules to alternating current (AC) electricity, e.g., for delivery to an electricity grid. Embodiments disclosed herein relate to methods and systems for using a solar energy system to charge a battery, or to power an electronic element, such as a processor, sensor, motor, moving assembly, or output device.

A ‘recipient system’ as used herein refers to any system or device which receives electricity produced by a solar energy system, or an array of PV modules. Examples of recipient systems include an DC to AC inverter for transmitting the produced electricity to an electrical grid, a chargeable battery, and the like.

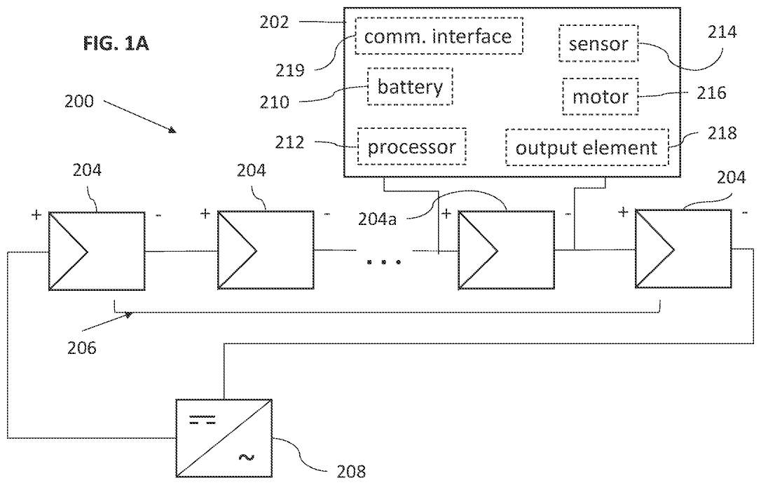

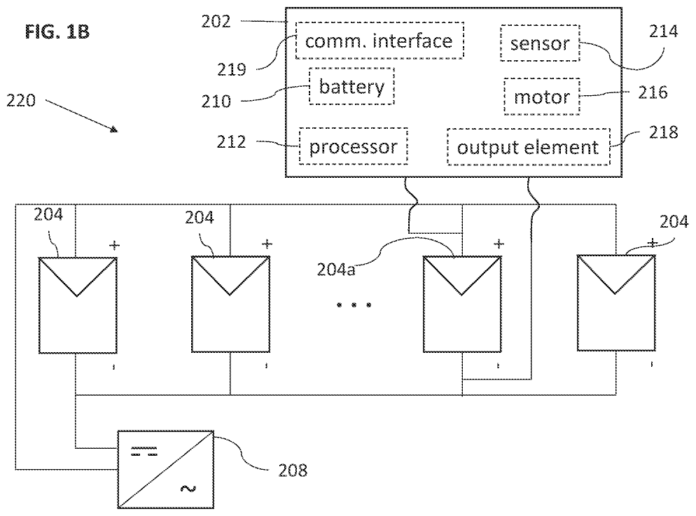

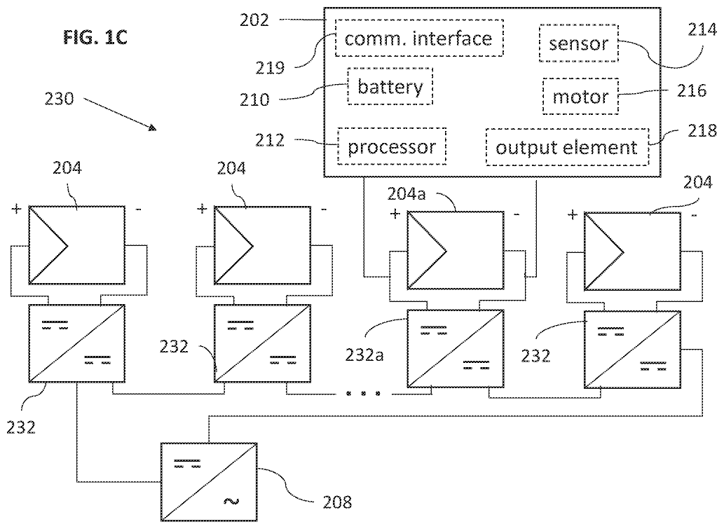

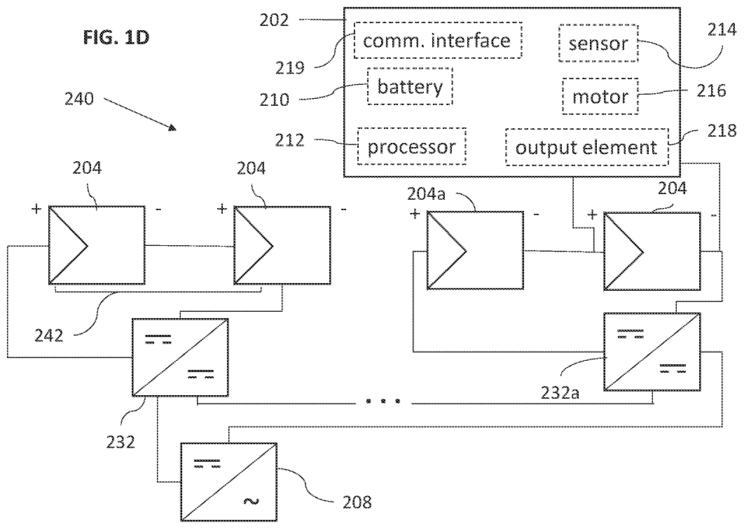

Reference is now made to FIGS. 1A, 1B, 1C, and 1D are schematic illustration of a photovoltaic (PV) energy systems powering an electronic element 202 according to embodiments of the present invention.

FIG. 1A shows a PV energy system 200 including a plurality of PV panels 204, which are electrically coupled to each other, in series, to form a string 206 of PV panels. The string 206 is electrically coupled to a recipient system, here shown as a DC to AC inverter 208, for transmission of produced electricity into an electrical grid. However, any other type of recipient system may be used, within the scope of the present application.

Each of PV panels 204 includes a negative terminal (indicated with a—symbol) and a positive terminal (indicated with a + symbol), and is typically formed of a plurality of PV cells. During use thereof, PV energy system 200, and specifically each of PV panels 204, produces electricity from sunlight applied thereto, as known in the art.

In accordance with the disclosed technology, electronic element 202 is electrically connected to the negative and positive terminals of one of PV panels 204a. When PV panels 204 are arranged in series as shown in FIG. 1A, electronic element 202 taps electricity from at least one line connecting PV panel 204a to a neighboring panel in string 206. In the illustrated embodiment, electronic element 202 taps electricity from lines connecting PV panel 204a to both its neighboring panels in string 206. However, if electronic element 202 taps electricity from a PV panel at an end of the string, one of the connections of electronic element 202 will be along a line between the PV panel being tapped, and DC to AC inverter 208, or another recipient system.

When electricity is produced in PV panel 204a, a portion of the electricity is tapped from the connections, and is used in electronic element 202. For example, electronic element 202 may include a battery 210, which may be charged by electricity produced by PV panel 204a and tapped from PV energy system 200. As another example, electronic element 202 may include a component requiring electricity for powering thereof, which electricity may be tapped from PV energy system 200. For example, the component to be powered may include one or more of:
a processor 212;
a sensor 214;
a moving or mobilizing assembly, such as a motor 216;
an output element 218, such as a speaker for outputting audio, an illuminator for outputting light, and the like; and
a communication interface 219, such as an interface for communication via the Internet (e.g. via a wired Internet connection, or via a wireless Internet connection such as a WiFi connection), via Bluetooth, or via a cellular telephone network.

The portion of electricity tapped by electronic element 202 depends on the specific components included in electronic element 202, and the function for which electricity is tapped. For example, during sensing or monitoring the tapped electricity may be suitable for production of 1 to 3 Watts. As another example, for operating a motor or moving assembly, the tapped electricity may be suitable for production of 5-Watts.

In some embodiments, the fraction of electricity tapped by electronic element 202, from the electricity produced by PV panel 204a, is at most 10%, at most 7%, at most 5%, at most 3%, at most 2%, or at most 1% of the produced electricity.

FIG. 1B is a schematic illustration of a PV energy system 220 powering electronic element 202 according to embodiments of the present invention. PV energy system 220 is substantially similar to PV energy system 200 shown in FIG. 1A, with like elements indicated by like reference numerals. However, in PV energy system 220 of FIG. 1B, the PV panels 204 are electrically coupled to each other, and to the recipient system (here DC to AC inverter 208) in parallel (unlike the coupling in series in FIG. 1A). As a result, no string of panels is formed.

Additionally, electronic element 202 taps electricity from lines connecting PV panel 204a to DC to AC inverter 208, rather than a line connecting the PV panel to other PV panels.

FIG. 1C is a schematic illustration of a PV energy system 230 powering electronic element 202 according to embodiments of the present invention. PV energy system 230 is similar to PV energy system 200 shown in FIG. 1A, with like elements indicated by like reference numerals. However, in PV energy system 230 of FIG. 1C, each of PV panels 204 is electrically coupled to a DC to DC converter 232, and the DC to DC converters 232 are electrically coupled to each other, in series. Suitable DC to DC converters are available, for example, from SolarEdge Technologies LTD, of Herzelia, Israel.

In the arrangement of FIG. 1C, electronic element 202 is connected to the circuit between PV panel 204a and a corresponding DC to DC converter 232a, and the series of DC to DC converters connected to the recipient system (here DC to AC inverter 208) remains untapped.

In some embodiments, DC to DC converters 232 may be electrically coupled to each other, and to DC to AC inverter 208, in parallel, rather than the serial connection shown in FIG. 1C.

FIG. 1D is a schematic illustration of a PV energy system 240 powering electronic element 202 according to embodiments of the present invention. PV energy system 240 is similar to PV energy system 230 shown in FIG. 1C, with like elements indicated by like reference numerals. However, in PV energy system 240 of FIG. 1D, each DC to DC converters 232 is electrically coupled to a sub-group 242 of PV panels 204, here shown as two PV panels 204, though any number of PV panels in the sub-group is considered within the scope of the disclosed technology. DC to DC converters 232 are coupled to each other, and to the recipient system (here DC to AC inverter 208), in series, as shown also in FIG. 1C.

In the illustrated embodiments, the PV panels within each sub-group are coupled to each other, and one of the DC to DC converters 232, in series. As such, each sub-group of PV panels forms a short string of PV panels, substantially as described hereinabove with respect to FIG. 1A.

In the arrangement of FIG. 1D, electronic element 202 taps electricity from at least one line connecting PV panel 204a to a neighboring panel in the sub-group. In the illustrated embodiment, electronic element 202 taps electricity from a line connecting PV panel 204a to one of its neighboring panels in the sub-group, and from another line connecting PV panel 204a to converter 232a. However, if electronic element 202 taps electricity from a PV panel in the center of the sub-group string, both connections of electronic element 202 will be along a line between the PV panel being tapped, and a neighboring panel.

In some embodiments, PV panels 204 in one or more of sub-groups 242 may be electrically coupled to each other, and to the corresponding DC to DC converter 232, in parallel, in a similar manner to that shown in FIG. 1B.

In some embodiments, DC to DC converters 232 may be electrically coupled to each other, and to DC to AC inverter 208 or another recipient system, in parallel.

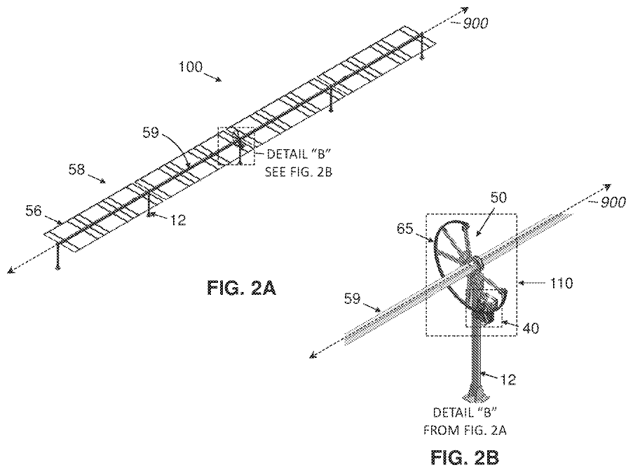

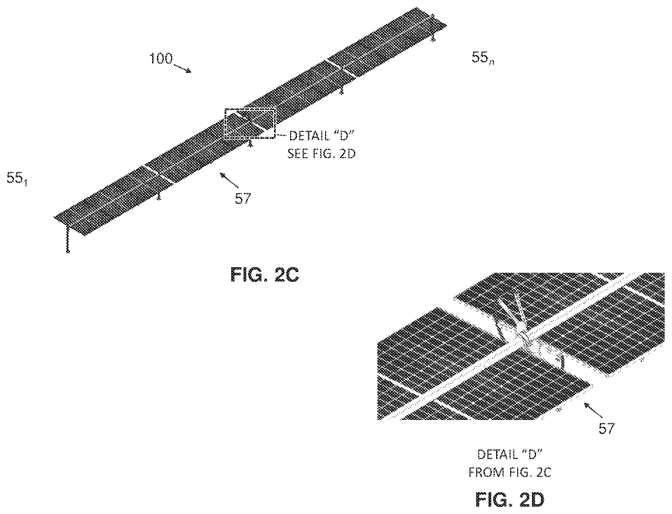

Referring now to FIGS. 2A, 2B, 2C and 2D, a solar energy system 100 according to embodiments includes a PV assembly 57. The PV assembly 57 includes an array of n PV panels 55₁ through 55ₙ, joined to a support subassembly 58. The support subassembly 58 includes an array of frames 56 for mounting the PV panels 55, and a central elongated member 59 to which the frames 56 are joined. The central elongated member 59 serves to transfer a torque to rotate the frames 56 as a unit together with the central elongated member 59 and the PV panels 55. The PV assembly 57 is rotated about a central longitudinal axis indicated in FIGS. 2C and 2D by arrow 900. The central elongated member 59 is pivotably supported by ground supports 12.

A drive system 110 according to embodiments includes a motor assembly 40 and a pivot wheel 50, and is also supported by a ground support 12. The drive system 110, as shown in FIG. 2A, can be located in the center of the PV assembly 57. In other examples, a drive system can be located elsewhere and/or configured differently than the example illustrated. In embodiments, the motor assembly 40 is operable to rotate a pivot wheel 50 which in turn is positioned to rotate the central elongated member 59 and, with it, the entire PV assembly 57. Drive system 110 may further include electronic circuitry for controlling operation of motor assembly 40. In some embodiments, the maximum pivot range of the pivot wheel 50 is pre-defined and programmed or programmable in the controller of the motor, such that, for example, the rotation is stopped by the controller at the end of a desired pivot range and does not apply excess tension to the chain. In some embodiments, the controller tracks the orientation of the pivot wheel 50. In some embodiments, the controller utilizes a feedback mechanism such as a mechanical, electromechanical or optical sensor which registers and/or transmits a pivot wheel position.

In accordance with embodiments of the disclosed technology, at least a portion of drive system 110 is powered by tapping electricity from a PV panel, as described hereinabove with respect to any one of FIGS. 1A to 1D.

In some embodiments, electricity for operation of drive system 110 is tapped from one of PV panels 55, mounted onto support subassembly 58. In some embodiments, electricity for operation of drive system 110 is tapped from another PV panel, not mounted onto support subassembly 58. The another PV panel may be mounted onto another support subassembly.

In some embodiments, multiple support subassemblies as shown in FIGS. 2A to 2D, each including a subset of PV panels, may be provided. Each of the support subassemblies may include a dedicated drive system 110, and each drive system 110 may be powered by tapping a different one of the PV panels.

In some embodiments, the power for operating each drive system 110 is tapped from a PV panel mounted onto the support subassembly driven by that drive system.

In some embodiments, the power for operating each drive system 110 is tapped from a PV panel mounted onto the support subassembly driven by the other drive system.

In some embodiments, the power for operating both drive systems is tapped from two PV panels mounted onto a single one of the support subassemblies.

It will be appreciated that the above descriptions are intended only to serve as examples, and that many other embodiments are possible within the scope of the present invention and as defined in the appended claim.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A solar energy system comprising:
a plurality of photovoltaic (PV) panels for production of electricity, the plurality of PV panels being electrically coupled to a recipient system receiving the produced electricity, each of the PV panels including a negative terminal and a positive terminal; and
an electronic element, including at least one component requiring power for operation or charging thereof, the electronic component being electrically connected to the negative terminal and to the positive terminal of one of the plurality of PV panels,
wherein, electricity for charging or powering the electronic element is tapped from electricity produced by the one of the plurality of PV panels, reducing an amount of the produced electricity being delivered to the recipient system.

2. The solar energy system of claim 1, wherein:
the plurality of PV panels are electrically coupled to each other, in series, to form a string of PV panels, and the string of PV panels is electrically coupled to the recipient system; and
the electronic element being electrically connected to the negative terminal and to the positive terminal between the one of the plurality of PV panels, and neighboring PV panels in the string of PV panels.

3. The solar energy system of claim 1, wherein:
the plurality of PV panels are electrically coupled to the recipient system in parallel; and
the electronic element being electrically connected to the negative terminal and to the positive terminal between the one of the plurality of PV panels, and the recipient system.

4. The solar energy system of claim 1, further comprising a plurality of DC to DC converters, wherein:
each of the plurality of PV panels is electrically coupled to a corresponding one of the plurality of DC to DC converters;
the plurality of DC to DC converters are electrically coupled to the recipient system; and
the electronic element being electrically connected to the negative terminal and to the positive terminal between the one of the plurality of PV panels and the corresponding DC to DC converter.

5. The solar energy system of claim 1, further comprising a plurality of DC to DC converters, wherein:
the plurality of PV panels is divided into sub-groups, each sub-group being electrically coupled to one of the plurality of DC to DC converters;
the plurality of DC to DC converters are electrically coupled to the recipient system; and
the electronic element being electrically connected to the negative terminal and to the positive terminal of a PV panel in one of the sub-groups.

6-9. (canceled)

10. The solar energy system of claim 1, wherein the recipient system comprises a DC to AC inverter, adapted to transmit electricity produced by the PV panels to an electrical grid.

11. The solar energy system of claim 1, wherein the recipient system comprises a battery, adapted to be charged by electricity produced by the PV panels.

12. The solar energy system of claim 1, wherein the electronic element comprises at least one battery, adapted to be charged by electricity tapped from the one of the plurality of PV panels.

13. The solar energy system of claim 1, wherein the electronic element adapted to be powered by electricity tapped from the one of the plurality of PV panels comprises at least one of:
a processor;
a sensor;
a motor;
an output element; and
a communication interface.

14-17. (canceled)

18. The solar energy system of claim 1, further comprising:
a support subassembly having at least a subset of the plurality of PV panels mounted thereonto, the support subassembly and the subset of PV panels mounted thereonto being pivotable about a longitudinal axis of the support subassembly; and
a drive system adapted to pivot the support subassembly and the subset of the plurality of PV panels mounted thereonto,
wherein the electronic element comprises at least a portion of the drive system, which is powered or charged by electricity tapped from the one of the plurality of PV panels.

19. The solar energy system of claim 18, wherein the electronic element comprises at least one of a motor, a CPU, and a controller of the drive system, adapted to be powered by the electricity tapped from the one of the plurality of PV panels.

20. The solar energy system of claim 18, wherein the electronic element comprises a backup battery of the drive system, adapted to be charged by the electricity tapped from the one of the plurality of PV panels, and to power other components of the drive system.

21. The solar energy system of claim 18, wherein the one of the plurality of PV panels is included in the subset of PV panels mounted onto the support subassembly.

22. The solar energy system of claim 18, wherein the one of the plurality of PV panels is excluded from the subset of PV panels mounted onto the support subassembly.

23. The solar energy system of claim 18, wherein all of the plurality of PV panels are mounted onto the support subassembly.

24-26. (canceled)

27. A method of charging a battery, or for powering an electronic element, using a plurality of PV panels for production of electricity, the plurality of PV panels delivering produced electricity to a recipient system, each of the PV panels including a negative terminal and a positive terminal, the method comprising:
electrically connecting the battery or the electronic element to the negative terminal and to the positive terminal of one of the plurality of PV panels; and
tapping electricity for charging the battery or for powering the electronic element from electricity produced by the one of the plurality of PV panels, thereby reducing the quantity of produced electricity being delivered to the recipient system.

28-30. (canceled)

31. The method of claim 27, wherein each of the plurality of PV panels is electrically coupled to a corresponding one of a plurality of DC to DC converters, which are electrically coupled to the recipient system, and wherein the electrically connecting comprises electrically connecting the battery or the electronic element to the negative terminal and to the positive terminal between the one of the plurality of PV panels and the corresponding DC to DC converter.

32-34. (canceled)

35. A method of driving pivoting of a PV assembly including an array of PV panels mounted onto a support subassembly, the support subassembly being pivotable when driven to pivot by a drive system, the method comprising:
electrically connecting the drive system to a negative terminal and to a positive terminal of a specific PV panel for production of electricity, the specific PV panel being electrically coupled to a recipient system; and
using electricity tapped from electricity generated by the specific PV panel, powering the drive system to drive pivoting of the support subassembly and the array of PV panels mounted thereon,
wherein the powering of the drive system by the tapped electricity causes a reduction in the electricity produced by the specific PV panel and delivered to the recipient system.

36. The method of claim 35, wherein the specific PV panel forms part of the array of PV panels mounted onto the support subassembly.

37. The method of claim 35, wherein the specific PV panel is not mounted onto the support subassembly.
